(19) United States
(12) Patent Application Publication
(10) Pub. No.: US 2024/0332592 A1
(43) Pub. Date: Oct. 3, 2024

(54) SECONDARY BATTERY AND ELECTRONIC APPARATUS

(71) Applicant: Dongguan Amperex Technology Limited, Dongguan (CN)

(72) Inventor: Jin WANG, Dongguan (CN)

(73) Assignee: Dongguan Amperex Technology Limited, Dongguan (CN)

(21) Appl. No.: 18/621,137

(22) Filed: Mar. 29, 2024

(30) Foreign Application Priority Data
Mar. 31, 2023 (CN) 202310350145.3

(51) Int. Cl. H01M 10/04; H01M 50/105; H01M 50/538

(52) U.S. Cl. CPC H01M 10/0431; H01M 50/105; H01M 50/538

(57) ABSTRACT

A secondary battery includes a housing, an electrode assembly, a first adhesive layer, and a second adhesive layer. The electrode assembly is disposed in the housing, the electrode assembly includes a wound first electrode plate, and a direction of a winding center axis of the electrode assembly is a first direction; and the first electrode plate includes a tail section forming an outermost ring of the electrode assembly, and the tail section includes a first surface facing away from the housing and a second surface facing towards the housing. The first adhesive layer includes a first portion bonded on the first surface and a second portion exceeding the tail section in the first direction. The second adhesive layer includes a third portion bonded on the second surface and a fourth portion exceeding the tail section in the first direction.

### CROSS-REFERENCE TO RELATED APPLICATION

This application claims priority from Chinese Patent Application No. 202310350145.3, filed on Mar. 31, 2023, the disclosure of which is hereby incorporated by reference in its entirety.

### TECHNICAL FIELD

This application relates to the field of energy storage technologies, and in particular, to a secondary battery and an electronic apparatus.

### BACKGROUND

With development of society and advancement of technologies, electronic apparatuses are increasingly widely applied and increasingly high reliability requirements are imposed on secondary batteries used in the electronic apparatuses.

Currently, in a production process of a secondary battery, adhesive paper is bonded on an electrode plate. If the adhesive paper completely covers the electrode plate and exceeds the electrode plate along a width direction of the electrode plate, a part of the adhesive paper that exceeds the electrode plate is folded during a packaging process of an electrode assembly, which causes a risk of causing the electrode plate to be folded when the adhesive paper is bonded on a housing, thereby reducing reliability of the secondary battery.

### SUMMARY

In view of this, it is necessary to provide a secondary battery capable of reducing a folding risk of an electrode plate.

Some embodiments of this application provide a secondary battery. The secondary battery includes a housing, an electrode assembly, a first adhesive layer, and a second adhesive layer. The electrode assembly is disposed in the housing, the electrode assembly includes a first electrode plate, a second electrode plate, and a separator sandwiched between the first electrode plate and the second electrode plate, the first electrode plate, the second electrode plate, and the separator are stacked and wound, and a direction of a winding center axis of the electrode assembly is a first direction. The first electrode plate includes a tail section, the tail section forms an outermost ring of the electrode assembly, and the tail section includes a first surface facing away from the housing and a second surface facing towards the housing. The first adhesive layer includes a first bonding layer, the first adhesive layer includes a first portion bonded on the first surface and a second portion exceeding the tail section in the first direction, and the first portion is connected to the second portion. The second adhesive layer includes a second bonding layer, the second adhesive layer includes a third portion bonded on the second surface and a fourth portion exceeding the tail section in the first direction, and the third portion is connected to the fourth portion. In a thickness direction of the tail section, the second adhesive layer, the first electrode plate, and the first adhesive layer are stacked sequentially, and the first bonding layer faces towards the second bonding layer; and in the thickness direction of the tail section, at least part of the fourth portion overlaps with the second portion.

In the foregoing embodiment, the first bonding layer and second bonding layer are disposed opposite each other, and at least part of the fourth portion overlaps with the second portion, so that the fourth portion covers at least part of the first bonding layer of the second portion that faces towards the housing, which helps reduce a risk of bonding between the second portion and the housing, thereby reducing a risk of causing the first electrode plate to be folded when the second portion is folded, and facilitating improvement of reliability of the secondary battery.

In some embodiments, the first adhesive layer is separated from the second adhesive layer.

In the foregoing embodiment, the first adhesive layer is separated from the second adhesive layer, which facilitates use of a taping structure to attach the second adhesive layer, thereby reducing difficulty of a taping process and improving consistency of taping effects.

In some embodiments, the first adhesive layer further includes a fifth portion, the fifth portion exceeds the tail section in the first direction, and the fifth portion, the first portion, and the second portion are connected sequentially in the first direction; the second adhesive layer further includes a sixth portion, the sixth portion exceeds the tail section in the first direction, and the sixth portion, the third portion, and the fourth portion are connected sequentially in the first direction; and at least part of the sixth portion overlaps with the fifth portion in the thickness direction of the tail section.

In the foregoing embodiment, at least part of the sixth portion overlaps with the fifth portion, which helps reduce the risk of bonding between the first bonding layer of the fifth portion and the housing, and further helps reduce a risk that the housing drives the fifth portion and the fifth portion drives the first electrode plate to be folded.

In some embodiments, the first adhesive layer further includes a fifth portion, the fifth portion exceeds the tail section in the first direction, and the fifth portion, the first portion, and the second portion are connected sequentially in the first direction; the secondary battery further includes a third adhesive layer, the third adhesive layer includes a seventh portion bonded on the second surface and an eighth portion exceeding the tail section in the first direction, the third adhesive layer is separated from the second adhesive layer, and the seventh portion is connected to the eighth portion; and at least part of the eighth portion overlaps with the fifth portion in the thickness direction of the tail section.

In the foregoing embodiment, at least part of the eighth portion overlaps with the fifth portion, which helps reduce the risk of bonding between the first bonding layer of the fifth portion and the housing, and further helps reduce a risk that the housing drives the fifth portion and the fifth portion drives the first electrode plate to be folded. In addition, the second adhesive layer is separated from the third adhesive layer, which helps reduce a length of an adhesive layer bonded on the second surface in the first direction, thereby saving the adhesive.

In some embodiments, the tail section includes a first straight section, a first bent section, a second straight section, and a second bent section connected sequentially in a winding direction, the electrode assembly includes a first end surface perpendicular to the first direction, and the second adhesive layer extends from the first straight section across the first end surface to the second straight section.

In the foregoing embodiment, the second adhesive layer extends from the first straight section across the first end surface to the second straight section, which helps the second adhesive layer bind the entire electrode assembly, thereby improving anti-drop performance of the secondary battery.

In some embodiments, the second portion and the fourth portion are integrated into an adhesive layer.

In the foregoing embodiment, the second portion and the fourth portion are integrated into an adhesive layer, so that a part of the integral adhesive layer that exceeds the tail section in the first direction is bonded on the second surface after being directly folded towards the second surface. Compared with the manner in which the first adhesive layer is separated from the second adhesive layer, the taping mechanism and a corresponding taping station dedicated to bonding of the second adhesive layer are reduced, which helps reduce costs.

In some embodiments, the first adhesive layer further includes a fifth portion, the fifth portion exceeds the tail section in the first direction, and the fifth portion, the first portion, and the second portion are connected sequentially in the first direction; the secondary battery further includes a third adhesive layer, the third adhesive layer includes a seventh portion pasted at the second surface and an eighth portion exceeding the tail section in the first direction, the third adhesive layer is separated from the second adhesive layer, and the seventh portion is connected to the eighth portion; and the third adhesive layer and the second adhesive layer are disposed sequentially in the first direction. The eighth portion and the fifth portion are integrated into an adhesive layer, and in the thickness direction of the tail section, at least part of the fourth portion overlaps with the second portion, and at least part of the eighth portion overlaps with the fifth portion.

In the foregoing embodiment, at least part of the eighth portion overlaps with the fifth portion, which helps reduce the risk of bonding between the first bonding layer of the fifth portion and the housing, and further helps reduce a risk that the housing drives the fifth portion and the fifth portion drives the first electrode plate to be folded.

In some embodiments, the third portion at least partially overlaps with the seventh portion in the thickness direction of the tail section.

In the foregoing embodiment, in the thickness direction of the tail section, the third portion and the seventh portion at least partially overlap, which helps increase an area of a part of the second adhesive layer that covers the second surface in the first direction, thereby improving an effect of the second adhesive layer to prevent exposure of debris generated by the first electrode plate during a puncture test or an impact test, and further reducing a risk of a short circuit caused by contact between exposed debris of the first electrode plate during the test and the second electrode plate.

In some embodiments, the secondary battery further includes a third adhesive layer and a fourth adhesive layer, the third adhesive layer includes a seventh portion bonded on the second surface and an eighth portion exceeding the tail section in the first direction, the third adhesive layer is separated from the second adhesive layer, and the seventh portion is connected to the eighth portion. The fourth adhesive layer includes a ninth portion bonded on the first surface and a tenth portion exceeding the tail section in the first direction, the fourth adhesive layer is separated from the first adhesive layer, and the ninth portion is connected to the tenth portion. The eighth portion and the tenth portion are integrated into an adhesive layer, and in the thickness direction of the tail section, at least part of the fourth portion overlaps with the second portion, and at least part of the eighth portion overlaps with the tenth portion.

In the foregoing embodiment, arrangement of the foregoing third adhesive layer and fourth adhesive layer further helps increase an area of a part of the first surface that is covered by the adhesive layer. In an embodiment in which the first section and the second section are disposed, attaching the first adhesive layer to a junction of the first section and the second section helps reduce the risk of piercing through the separator by an active substance trailing from the first section and a risk of lithium precipitation, and further helps reduce a risk of a short circuit caused by contact between the first electrode plate and burrs at a tail of the second electrode plate that pierces through the separator.

In some embodiments, the housing is an aluminum-plastic film packaging bag.

In some embodiments, there is first peel strength between the first portion and the first surface, there is second peel strength between third portion and the second surface, and the first peel strength is less than the second peel strength.

In the foregoing embodiment, the second bonding strength is greater than the first bonding strength, which helps reduce a bonding failure risk of the first adhesive layer and the second adhesive layer, thereby reducing a risk of bonding between the second portion of the first adhesive layer and the housing.

In some embodiments, the electrode assembly further includes an electrode terminal, the housing includes a first end and a second end disposed opposite each other in the first direction, the electrode terminal is located at the first end, and the second portion and the fourth portion are located at the second end; and the housing also includes a first packaging portion and a second packaging portion, and the first packaging portion and the second packaging portion are integrated at the second end.

In some embodiments, the tail section includes a first straight section, a first bent section, a second straight section, and a second bent section connected sequentially in a winding direction, and at least part of the first portion is bonded on a first surface of the first straight section or a first surface of the second straight section.

In the foregoing embodiment, at least part of the first portion is bonded to the first surface of the first straight section or the first surface of the second straight section, to reduce a thickness difference of the secondary battery when the wound electrode assembly ends at the first straight section or the second straight section.

In some embodiments, in the first direction, a length of the second portion is L1, and a length of the fourth portion is L2, where L1<L2.

In the foregoing embodiment, L1<L2, so that the fourth portion covers the first bonding layer of the second portion, thereby reducing a risk of bonding between the second portion and the housing.

In addition, this application further provides an electronic apparatus facilitating reliability improvement.

Some embodiments of this application provide an electronic apparatus. The electronic apparatus includes the secondary battery in any one of the foregoing embodiments.

In the foregoing embodiment, a probability of folding the first electrode plate in the secondary battery is reduced, which helps improve the reliability of the secondary battery, thereby improving the reliability of the electronic apparatus.

The secondary battery in this application includes a housing, an electrode assembly, a first adhesive layer, and a second adhesive layer. The electrode assembly is disposed in the housing, the electrode assembly includes a wound first electrode plate, and a direction of a winding center axis of the electrode assembly is a first direction;

and the first electrode plate includes a tail section forming an outermost ring of the electrode assembly, and the tail section includes a first surface facing away from the housing and a second surface facing towards the housing. The first adhesive layer includes a first portion bonded on the first surface and a second portion exceeding the tail section in the first direction. The second adhesive layer includes a third portion bonded on the second surface and a fourth portion exceeding the tail section in the first direction. In a thickness direction of the tail section, the second adhesive layer, the first electrode plate, and the first adhesive layer are stacked sequentially; and at least part of the fourth portion overlaps with the second portion. The foregoing first bonding layer and second bonding layer are disposed opposite each other, and at least part of the fourth portion overlaps with the second portion, so that the fourth portion covers the first bonding layer of the second portion that faces towards the housing, which helps reduce a risk of bonding between the second portion and the housing, thereby reducing a risk of causing the first electrode plate to be folded when the second portion is folded, and facilitating improvement of reliability of the secondary battery.

### BRIEF DESCRIPTION OF DRAWINGS

FIG. 1 is a schematic structural diagram of a secondary battery according to an embodiment of this application;

FIG. 2 is a schematic cross-sectional view of the secondary battery in the embodiment in FIG. 1 along a section line C-C;

FIG. 3 is a schematic diagram of assembling the secondary battery in FIG. 1;

FIG. 4 is a schematic cross-sectional view of the secondary battery in the embodiment in FIG. 1 along a section line C-C;

FIG. 5 is a schematic diagram of an unfolded tail section, first adhesive layer, and second adhesive layer according to an embodiment of this application;

FIG. 6 is a schematic diagram of an unfolded tail section, first adhesive layer, and second adhesive layer according to another embodiment of this application;

FIG. 7 is a schematic diagram of the tail section, the first adhesive layer, and the second adhesive layer in FIG. 5 from another perspective;

FIG. 8 is a schematic diagram of an unfolded tail section, first adhesive layer, and second adhesive layer according to still another embodiment of this application;

FIG. 9 is a schematic diagram of an unfolded tail section, first adhesive layer, second adhesive layer, and third adhesive layer according to an embodiment of this application;

FIG. 10 is a schematic diagram of a first end surface of a secondary battery with a hidden housing according to an embodiment of this application;

FIG. 11 is a schematic diagram of an electrode assembly, a first adhesive layer, and a second adhesive layer when viewed in a direction from a first bent section to a second bent section according to another embodiment of this application;

FIG. 12 is a schematic diagram of an unfolded tail section, first adhesive layer, and second adhesive layer according to yet another embodiment of this application;

FIG. 13 is a schematic diagram of an unfolded tail section, first adhesive layer, second adhesive layer, and third adhesive layer according to another embodiment of this application;

FIG. 14 is a schematic diagram of an unfolded tail section, first adhesive layer, and second adhesive layer according to still yet another embodiment of this application;

FIG. 15 is a schematic diagram of an unfolded tail section, first adhesive layer, second adhesive layer, third adhesive layer, and fourth adhesive layer according to an embodiment of this application;

FIG. 16 is a schematic diagram of an unfolded tail section, first adhesive layer, second adhesive layer, third adhesive layer, and fourth adhesive layer according to another embodiment of this application; and

FIG. 17 is a schematic diagram of an electronic apparatus according to an embodiment of this application.

### REFERENCE SIGNS OF MAIN ELEMENTS

Secondary battery 100
Housing 10
Main body 11
Edge banding portion 12
First packaging portion 13
Second packaging portion 14
First end 15
Second end 16
Electrode assembly 20
First electrode plate 21
Tail section 211
First surface 211a
First section 2111a
Second section 2112a
Second surface 211b
First straight section 2111
First side portion 2111b
Second side portion 2111c
First bent section 2112
Second straight section 2113
Second bent section 2114
Second electrode plate 22
Separator 23
First end surface 24
Second end surface 25
First electrode terminal 101
Second electrode terminal 102
First adhesive layer 30
First matrix layer 31
First bonding layer 32
First portion 33
Second portion 34
Fifth portion 35
Second adhesive layer 40
Second matrix layer 41
Second bonding layer 42
Third portion 43
Fourth portion 44
Sixth portion 45
Third adhesive layer 50
Seventh portion 51
Eighth portion 52
Fourth adhesive layer 60
Ninth portion 61
Tenth portion 62
First direction X
Second direction Y
Third direction Z
Electronic apparatus 1000

### DETAILED DESCRIPTION

The following describes the technical solutions in the embodiments of this application with reference to the accompanying drawings in the embodiments of this application. Apparently, the described embodiments are only some rather than all of the embodiments of this application.

It should be noted that, when deemed as being “connected to” another component, one component can be directly connected to the another component, or there can be an in-between component. When deemed as being “disposed on” another component, one component can be directly disposed on the another component, or there can be an in-between component. The terms “top”, “bottom”, “upper”, “lower”, “left”, “right”, “front”, “rear”, and other similar expressions as used herein are for illustration only.

The term “perpendicular” is used to describe an ideal state between two components. During actual production or use, two components may be in a nearly perpendicular state. For example, with reference to numbers, “perpendicular” can indicate an included angle range of 90°±10° between two straight lines, or a dihedral angle range of 90°±10° between two planes, or an included angle range of 90°±10° between the straight line and a plane. The two “perpendicular” components may not be absolute straight lines or planes, and may also be approximate straight lines or planes. When forming straight lines or planes in an overall extension direction from a macroscopic perspective, the components can be considered as “straight lines” or “planes”.

It should be noted that when a specific parameter is greater than, equal to, or less than a specific endpoint value, it should be understood that the endpoint value has a tolerance of ±5%.

Unless otherwise defined, all technical and scientific terms used herein shall have the same meanings as commonly understood by those skilled in the art to which this application pertains. The terms used herein in the specification of this application are only used to describe specific embodiments, and are not intended to limit this application.

This application discloses a secondary battery. The secondary battery includes a housing, an electrode assembly, a first adhesive layer, and a second adhesive layer. The electrode assembly is disposed in the housing, the electrode assembly includes a first electrode plate, a second electrode plate, and a separator 23 sandwiched between the first electrode plate and the second electrode plate, the first electrode plate, the second electrode plate, and the separator 23 are stacked and wound, and a direction of a winding center axis of the electrode assembly is a first direction. The first electrode plate includes a tail section, the tail section forms an outermost ring of the electrode assembly, and the tail section includes a first surface 211a facing away from the housing and a second surface 211b facing towards the housing. The first adhesive layer includes a first bonding layer, the first adhesive layer includes a first portion bonded on the first surface 211a and a second portion exceeding the tail section in the first direction, and the first portion is connected to the second portion. The second adhesive layer includes a second bonding layer, the second adhesive layer includes a third portion bonded on the second surface 211b and a fourth portion exceeding the tail section in the first direction, and the third portion is connected to the fourth portion. In a thickness direction of the tail section, the second adhesive layer, the first electrode plate, and the first adhesive layer are stacked sequentially, and the first bonding layer faces towards the second bonding layer; and in the thickness direction of the tail section, at least part of the fourth portion overlaps with the second portion.

The foregoing first bonding layer and second bonding layer are disposed opposite each other, and at least part of the fourth portion overlaps with the second portion, so that the fourth portion covers at least part of the first bonding layer of the second portion that faces towards the housing, which helps reduce a risk of bonding between the second portion and the housing, thereby reducing a risk of causing the first electrode plate to be folded when the second portion is folded, and facilitating improvement of reliability of the secondary battery.

The following describes some embodiments of this application with reference to accompanying drawings. In absence of conflicts, the following embodiments and features in the embodiments may be combined.

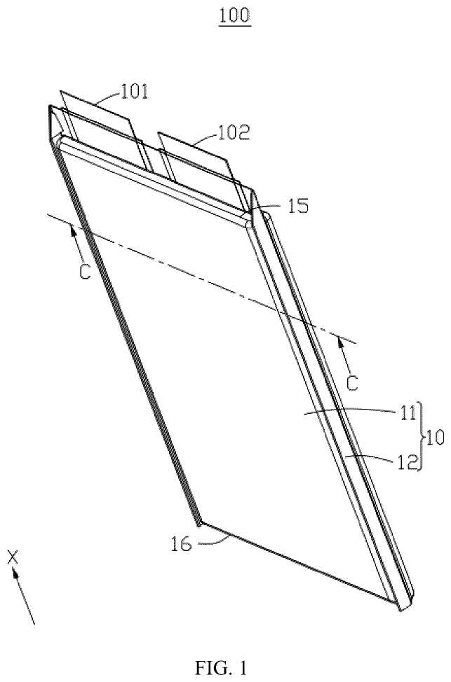

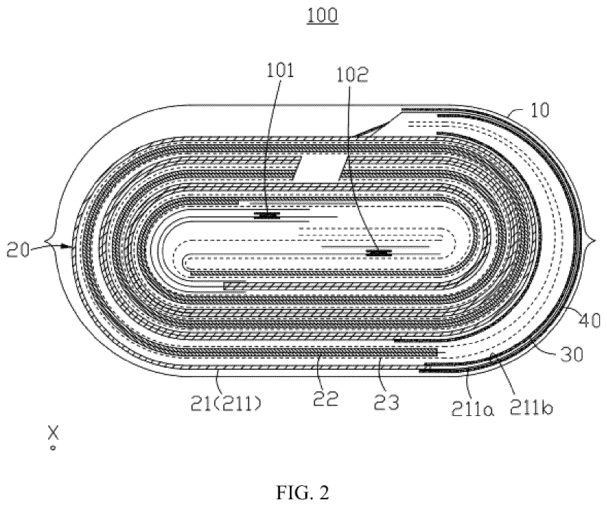

Referring to FIG. 1 and FIG. 2, an embodiment of this application provides a secondary battery 100. The secondary battery 100 includes a housing 10, an electrode assembly 20, a first adhesive layer 30, and a second adhesive layer 40. The electrode assembly 20 is disposed in the housing 10, the electrode assembly 20 includes a first electrode plate 21, a second electrode plate 22, and a separator 23 sandwiched between the first electrode plate 21 and the second electrode plate 22, and the first electrode plate 21, the second electrode plate 22, and the separator 23 are stacked and wound. The first electrode plate 21 includes a tail section 211, the tail section 211 forms an outermost ring of the electrode assembly 20, and the tail section 211 includes a first surface 211a facing away from the housing 10 and a second surface 211b facing towards the housing 10. The first adhesive layer 30 is bonded to the first surface 211a, the second adhesive layer 40 is bonded to the second surface 211b, and the second adhesive layer 40 is also bonded to the first adhesive layer 30.

When the tail section 211 forms the outermost ring of the electrode assembly 20, it can be considered as a meaning that an entire outermost ring of layer structure of the electrode assembly 20 in the wound structure is the first electrode plate 21, and a part of the first electrode plate 21 that is located in the outermost ring is the tail section 211 of the first electrode plate 21.

In some embodiments, in the thickness direction of the electrode assembly 20, a winding start portion of the first electrode plate 21 overlaps with a winding end portion of the tail section 211 of the first electrode plate 21.

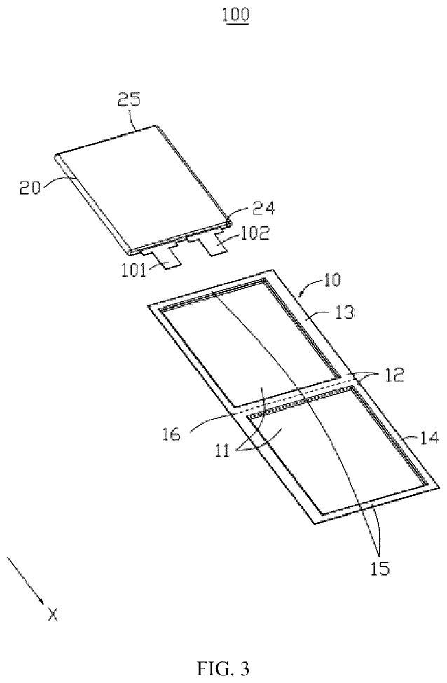

In some embodiments, referring to FIG. 1 and FIG. 3, the housing 10 has a main body 11 and an edge banding portion 12, the main body 11 is configured to accommodate the electrode assembly 20, and the edge banding portion 12 extends outwards from a peripheral side of the main body 11. The housing 10 includes a first packaging portion 13 and a second packaging portion 14, one side of the first packaging portion 13 is connected to one side of the second packaging portion 14, and the first packaging portion 13 and the second packaging portion 14 are folded towards each other along a connection position until a peripheral edge of the first packaging portion 13 comes into contact with a peripheral edge of the second packaging portion 14. Separated parts of the first packaging portion 13 and the second packaging portion 14 form the main body 11, and the peripheral edge of the first packaging portion 13 and the peripheral edge of the second packaging portion 14 that come into contact with each other are sealed, to form the edge banding portion 12.

In some embodiments, after the peripheral edge of the first packaging portion 13 comes into contact with the peripheral edge of the second packaging portion 14, air between the first packaging portion 13 and the second packaging portion 14 can also be extracted, which facilitates improvement of contact tightness between the first packaging portion 13, the second packaging portion 14, and the electrode assembly 20.

In some embodiments, referring to FIG. 1 and FIG. 3, the housing 10 has a first end 15 and a second end 16 disposed opposite each other, the second end 16 of the housing 10 is a part formed via connection and folding of a side of the first packaging portion 13 and a side of the second packaging portion 14, and the first packaging portion 13 and the second packaging portion 14 are connected via integration. That is, the second end 16 of the housing 10 is integrally formed.

In some embodiments, the peripheral edge of the first packaging portion 13 and the peripheral edge of the second packaging portion 14 come into contact with each other and are sealed to form a packaging bag.

In some embodiments, the first packaging portion 13 and the second packaging portion 14 can be made of a non-metallic material such as plastic, rubber, or a carbon fiber composite material, or can be made of a metal material such as copper, iron or aluminum alloy. The first packaging portion 13 and the second packaging portion 14 can also be made of multiple materials such as an aluminum-plastic film. The first packaging portion 13 and the second packaging portion 14 may be made of the same material or different materials.

In some embodiments, the first electrode plate 21 and the second electrode plate 22 have opposite polarities, one of the first electrode plate 21 and the second electrode plate 22 is a positive electrode plate, and the other one of the first electrode plate 21 and the second electrode plate 22 is a negative electrode plate. The electrode plate is formed by integrating an active material layer onto a metal layer, and electrode plates with different polarities use different metal materials and active materials with different polarities.

The positive electrode active material may be one or more of lithium nickel cobalt manganate, lithium cobalt oxide, lithium iron phosphate, lithium manganate oxide, lithium manganese iron phosphate, a cobalt-free material, or a sodium-ion material. The negative electrode active material can be one or more of artificial graphite, natural graphite, or a silicon material.

As an illustrative example, the first electrode plate 21 is a positive electrode plate, the first electrode plate 21 is formed by integrating a positive electrode active material onto an aluminum metal layer, the second electrode plate 22 is a negative electrode plate, and the second electrode plate 22 is formed by integrating a negative electrode active material onto a copper metal layer.

In some embodiments, the separator 23 is an insulating film material such as a polyethylene film, a polypropylene film, a polyester film, or a polyimide film, to isolate the first electrode plate 21 from the second electrode plate 22.

In some embodiments, referring to FIG. 1 to FIG. 3, the secondary battery 100 further includes a first electrode terminal 101 and a second electrode terminal 102, the first electrode plate 21 is connected to the first electrode terminal 101, and the second electrode plate 22 is connected to the second electrode terminal 102. The first electrode terminal 101 connected with the first electrode plate 21 has the same polarity as the first electrode plate 21, and the second electrode terminal 102 connected with the second electrode plate 22 has the same polarity as the second electrode plate 22. At least part of the first electrode terminal 101 and the second electrode terminal 102 extend out of the housing 10, to extend out the first electrode plate 21 and the second electrode plate 22 with polarities.

In some embodiments, referring to FIG. 1 and FIG. 3, both the first electrode terminal 101 and the second electrode terminal 102 extend out of the housing 10 from the first end 15.

In some embodiments, the first electrode terminal 101 is made of the same material as the first electrode plate 21, and the second electrode terminal 102 is made of the same material as the second electrode plate 22.

Referring to FIG. 3 to FIG. 5, a direction along a central axis of the wound structure is defined as a first direction X, and the first direction X is a width direction of the first electrode plate 21 and the second electrode plate 22, it is defined that the first electrode plate 21 is wound along the length direction of the first electrode plate 21 and the second electrode plate 22 is wound along a length direction of the second electrode plate 22, in an unfolded state in which the first electrode plate 21 and the second electrode plate 22 are not wound, the length direction of the first electrode plate 21 and the second electrode plate 22 is the second direction Y, a thickness direction of the first electrode plate 21 and the second electrode plate 22 is a third direction Z, and any two of the first direction X, the second direction Y, and the third direction Z are perpendicular to each other.

It can be understood that, in the winding state, thickness directions of the first electrode plate 21 at different positions are different, thickness directions of the tail section 211 at different positions are also different, and a thickness direction of the tail section 211 is perpendicular to the winding direction of the tail section 211.

Referring to FIG. 3 to FIG. 5, after the first electrode plate 21, the second electrode plate 22, and the separator 23 are stacked and wound to form the electrode assembly 20 with a wound structure, the electrode assembly 20 has a first end surface 24 and a second end surface 25 disposed opposite each other along the first direction X, the outermost ring of the electrode assembly 20 is the tail section 211 of the first electrode plate 21, and the tail section 211 includes a first surface 211a facing away from the housing 10 and a second surface 211b facing towards the housing 10.

In some embodiments, both the first end surface 24 and the second end surface 25 are perpendicular to the first direction X.

In some embodiments, the first electrode terminal 101 connected to the first electrode plate 21 and the second electrode terminal 102 connected to the second electrode plate 22 both extend outwards from the first end surface 24.

In another embodiment, the first electrode terminal 101 connected to the first electrode plate 21 and the second electrode terminal 102 connected to the second electrode plate 22 can both extend outwards from the second end surface 25; or one of the first electrode terminal 101 connected to the first electrode plate 21 and the second electrode terminal 102 connected to the second electrode plate 22 extends outwards from the first end surface 24, and the other one extends outwards from the second end surface 25, which is not specifically limited herein.

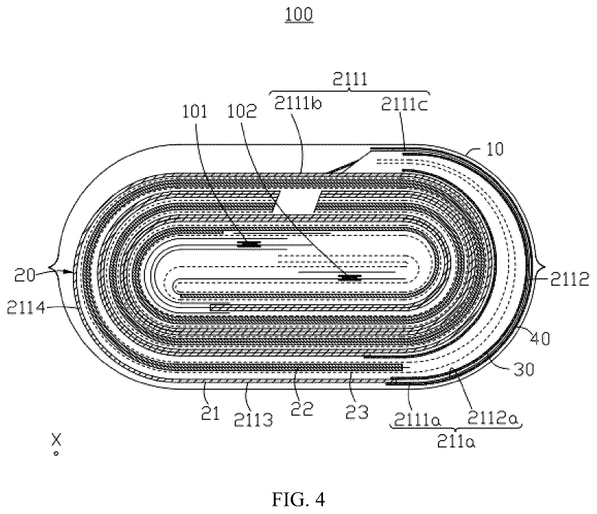

In some embodiments, referring to FIG. 1 and FIG. 4, the first surface 211a has a first section 2111a combined with an active substance and a second section 2112a not combined with an active substance layer, and the entire second surface 211b is not coated with an active substance.

In some embodiments, referring to FIG. 4, the tail section 211 includes a first straight section 2111, a first bent section 2112, a second straight section 2113, and a second bent section 2114 that are connected sequentially in the winding direction.

In some embodiments, referring to FIG. 4, an ending portion of the tail section 211 is fixed with an ending glue, and is located at the first straight section 2111 or the second straight section 2113. For example, if the ending portion is at the first straight section 2111, the ending portion is used as a boundary, assuming that the first straight section 2111 includes a first side portion 2111b and a second side portion 2111c, along a direction from the first straight section 2111 to the second straight section 2113, a thickness of a part of the electrode assembly 20 that corresponds to the first side portion 2111b is less than a thickness of a part of the electrode assembly 20 that corresponds to the second side portion 2111c. For another example, if the ending portion is at the second straight section 2113, the ending portion is used as a boundary, assuming that the second straight section 2113 includes a first side portion 2111b and a second side portion 2111c, along a direction from the first straight section 2111 to the second straight section 2113, a thickness of a part of the electrode assembly 20 that corresponds to the first side portion 2111b is less than a thickness of a part of the electrode assembly 20 that corresponds to the second side portion 2111c.

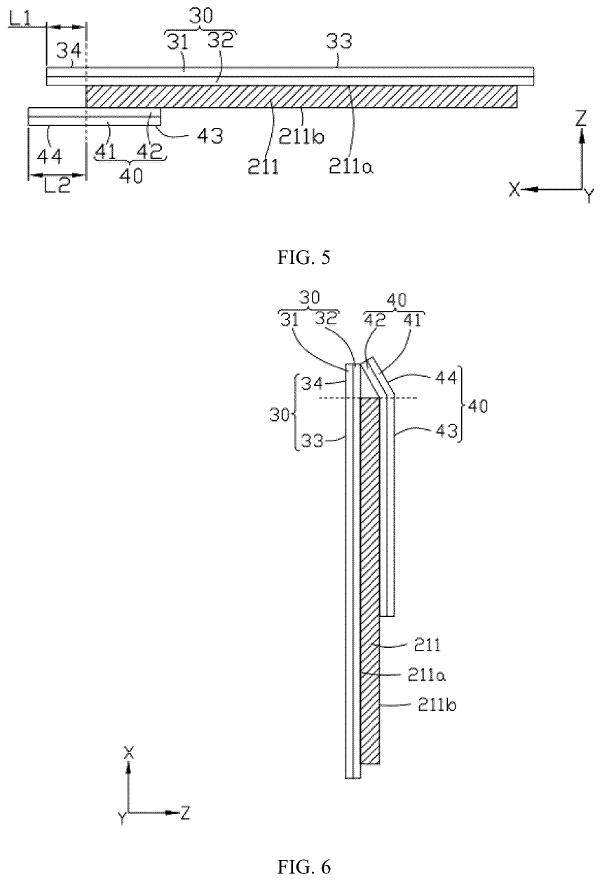

Referring to FIG. 5, the first adhesive layer 30 includes a first matrix layer 31 and a first bonding layer 32 bonded to the first matrix layer 31, and the first bonding layer 32 has adhesiveness. The first adhesive layer 30 includes a first portion 33 bonded on the first surface 211a and a second portion 34 exceeding the tail section 211 in the first direction X, and the first portion 33 is connected to the second portion 34, so that the first adhesive layer 30 is easily bonded on the first surface 211a with such setting.

In the related art, after the first adhesive layer 30 is bonded on the first surface 211a, the second portion 34 exceeds the tail section 211, the first bonding layer 32 of the second portion 34 faces towards the housing 10, and when the wound electrode assembly 20 is packaged, there is a risk of bonding the second portion 34 to the housing 10. If the second portion 34 is bonded to the housing 10, when the secondary battery 100 is packaged, disassembled, or impacted during transportation and use, there is a risk that the housing 10 drives the second portion 34 and the first adhesive layer 30 drives the first electrode plate 21 to be folded, thereby further reducing the reliability of the secondary battery 100. For example, when the first packaging portion 13 and the second packaging portion 14 are folded towards each other or farther away from each other along a connection position, the first packaging portion 13 or the second packaging portion 14 may drive the second portion 34 to be folded. For another example, when the secondary battery 100 is impacted, the first packaging portion 13 and the second packaging portion 14 partially deform, which can drive the second portion 34 to be folded.

Referring to FIG. 5 and FIG. 6, in this embodiment of this application, the second adhesive layer 40 includes a second matrix layer 41 and a second bonding layer 42 bonded to the second matrix layer 41, and the second bonding layer 42 has adhesiveness. The second adhesive layer 40 includes a third portion 43 bonded on the second surface 211b and a fourth portion 44 exceeding the tail section 211 in the first direction X, and the third portion 43 is connected to the fourth portion 44. In a third direction Z, the second adhesive layer 40, the first electrode plate 21, and the first adhesive layer 30 are stacked sequentially, and the first bonding layer 32 faces towards the second bonding layer 42; and in the third direction Z, at least part of the fourth portion 44 overlaps with the second portion 34. In this embodiment, the first bonding layer 32 faces towards the second bonding layer 42, and at least part of the fourth portion 44 overlaps with the second portion 34, so that the fourth portion 44 covers at least part of the first bonding layer 32 of the second portion 34 that faces towards the housing 10, which helps reduce a risk of bonding between the second portion 34 and the housing 10, thereby reducing a risk of causing the first electrode plate 21 to be folded when the second portion 34 is folded, and facilitating improvement of reliability of the secondary battery 100.

In some embodiments, referring to FIG. 5 and FIG. 6, the first bonding layer 32 and the second bonding layer 42 are connected, thereby reducing a risk of bonding between the second portion 34 and the housing 10.

In some embodiments, the material used for the first matrix layer 31 and the second matrix layer 41 includes at least one of polyethylene terephthalate, polyimide, or polypropylene. The first matrix layer 31 and the second matrix layer may be made of same material or different materials.

In some embodiments, the first bonding layer 32 and the second bonding layer 42 include a binder; and the binder includes at least one of polymethyl methacrylate, polypropylene, polyethylene, polyamide, styrene-butadiene rubber, nitrile rubber, cis-butadiene rubber, isoprene rubber, ethylene-propylene rubber, or neoprene. The binder of the first bonding layer 32 and the binder of the second bonding layer 42 may be made of same material or different materials.

In some embodiments, referring to FIG. 5 and FIG. 6, the first adhesive layer 30 is separated from the second adhesive layer 40. The first adhesive layer 30 is separated from the second adhesive layer 40, which facilitates use of a taping mechanism to attach the second adhesive layer 40, thereby reducing difficulty of a taping process and improving consistency of taping effects.

In some embodiments, referring to FIG. 5 and FIG. 6, in the first direction X, a length of the second portion 34 is L1, a length of the fourth portion 44 is L2, where L1<L2, so that the fourth portion 44 covers the first bonding layer 32 of the second portion 34, thereby reducing a risk of bonding between the second portion 34 and the housing 10.

In some embodiments, L1 is greater than 0 millimeters and less than 4 millimeters, and a part of the first adhesive layer 30 that can exceed the first electrode plate 21 in the first direction X is reserved, which facilitates a taping operation of a taping mechanism, and facilitates a reduction in a risk that energy density and packaging strength of the battery are reduced because the first adhesive layer 30 is excessively long.

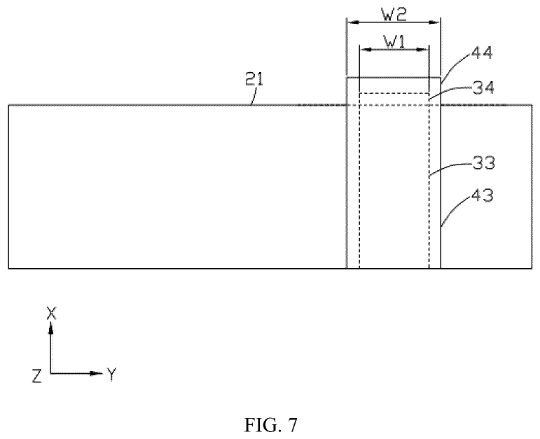

In some embodiments, referring to FIG. 7 in a winding direction of the first electrode plate 21, a width of the second portion 34 is W1, a width of the fourth portion 44 is W2, where W1≤W2, so that the fourth portion 44 covers the first bonding layer 32 of the second portion 34, thereby reducing a risk of bonding between the second portion 34 and the housing 10.

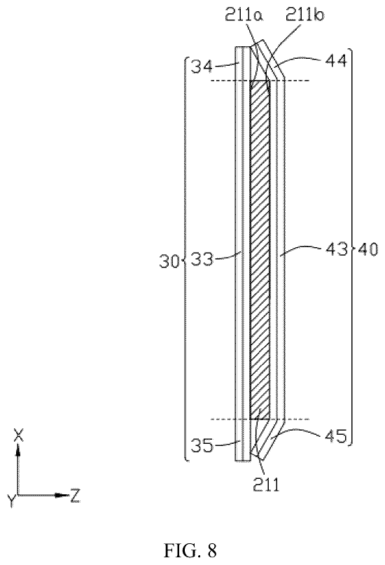

In some embodiments, referring to FIG. 8, the first adhesive layer 30 further includes a fifth portion 35, the fifth portion 35 exceeds the tail section 211 in the first direction X, and the fifth portion 35, the first portion 33, and the second portion 34 are connected sequentially in the first direction X. When the fifth portion 35 exceeds the tail section 211, which helps increase an area of a part of the first surface 211a that is covered by the first adhesive layer 30 along the first direction X. Referring to FIG. 4, in an embodiment in which the first section 2111a and the second section 2112a are disposed, attaching the first adhesive layer 30 to a junction of the first section 2111a and the second section 2112a helps reduce the risk of piercing through the separator 23 by an active substance trailing from the first section 2111a and a risk of lithium precipitation, and further helps reduce a risk of a short circuit caused by contact between the first electrode plate 21 and burrs at a tail of the second electrode plate 22 that pierces through the separator 23.

In some embodiments, referring to FIG. 8, the second adhesive layer 40 further includes a sixth portion 45, the sixth portion 45 exceeds the tail section 211 in the first direction X, and the sixth portion 45, the third portion 43, and the fourth portion 44 are connected sequentially in the first direction X; and at least part of the sixth portion 45 overlaps with the fifth portion 35 in the third direction Z. At least part of the sixth portion 45 overlaps with the fifth portion 35, which helps reduce the risk of bonding between the first bonding layer 32 of the fifth portion 35 and the housing 10, and further helps reduce a risk that the housing 10 drives the fifth portion 35 and the fifth portion 35 drives the first electrode plate 21 to be folded.

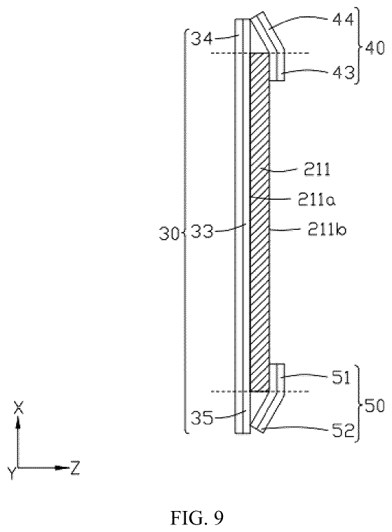

In some other embodiments, referring to FIG. 9, the secondary battery 100 further includes a third adhesive layer 50, the third adhesive layer 50 is separated from the second adhesive layer 40, and in a third direction Z, the first adhesive layer 30, the first electrode plate 21, and the third adhesive layer 50 are stacked sequentially. The third adhesive layer 50 includes a third matrix layer and a third bonding layer, the third bonding layer and the first bonding layer 32 are disposed opposite each other, the third adhesive layer 50 includes a seventh portion 51 bonded at the second surface 211b and an eighth portion 52 exceeding the tail section 211 in the first direction X, and the seventh portion 51 is connected to the eighth portion 52; and in the third direction Z, at least part of the eighth portion 52 overlaps with the fifth portion 35. At least part of the eighth portion 52 overlaps with the fifth portion 35, which helps reduce the risk of bonding between the first bonding layer 32 of the fifth portion 35 and the housing 10, and further helps reduce a risk that the housing 10 drives the fifth portion 35 and the fifth portion 35 drives the first electrode plate 21 to be folded. In addition, the second adhesive layer 40 is separated from the third adhesive layer 50, which helps reduce a length of an adhesive layer bonded on the second surface 211b in the first direction X, thereby saving the adhesive.

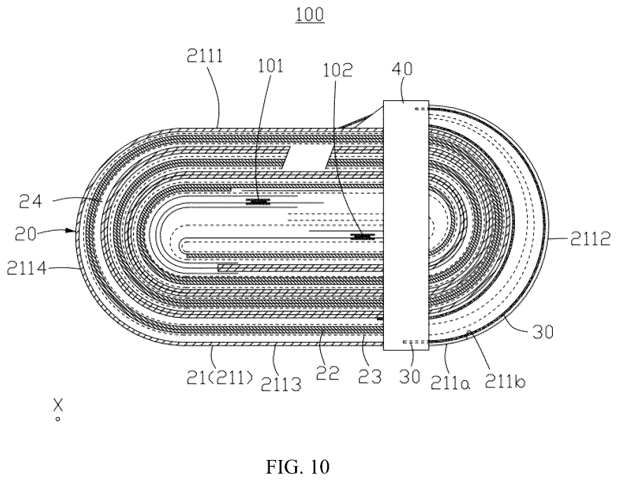

In some embodiments, referring to FIG. 10, the second adhesive layer 40 extends from the first straight section 2111 across the first end surface 24 of the electrode assembly 20 to the second straight section 2113, which helps the second adhesive layer 40 bind the entire electrode assembly 20, thereby improving anti-drop performance of the secondary battery 100.

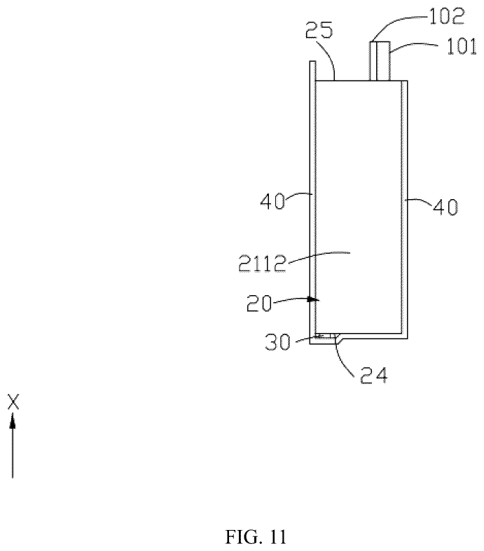

In some embodiments, referring to FIG. 11, the first electrode terminal 101 connected to the first electrode plate 21 and the second electrode terminal 102 connected to the second electrode plate 22 both extend outwards from the second end surface 25, and the second adhesive layer 40 extends from the first straight section 2111 across the first end surface 24 of the electrode assembly 20 to the second straight section 2113, which helps the second adhesive layer 40 bind the entire electrode assembly 20, thereby improving the anti-drop performance of the secondary battery 100.

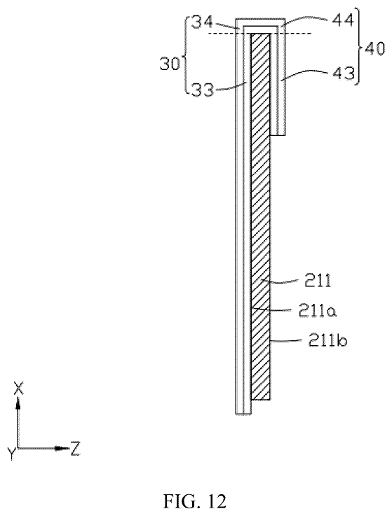

In some embodiments, referring to FIG. 12, the second portion 34 and the fourth portion 44 are integrated into an adhesive layer.

It should be noted that integration can be understood as forming a continuous integrity, and when the second portion 34 and the fourth portion 44 are integrated into the adhesive layer, it can be considered as a meaning that the second portion 34 and the fourth portion 44 are a continuous integral adhesive layer. For example, the second portion 34 and the fourth portion 44 can be integrated into the adhesive layer that is integrally formed. The first adhesive layer 30 and the second adhesive layer 40 are integrated into the adhesive layer, so that a part of a continuous adhesive layer that exceeds the tail section 211 in the first direction X is bonded on the second surface 211b after being directly folded towards the second surface 211b. Compared with the manner in which the first adhesive layer 30 is separated from the second adhesive layer 40, the taping mechanism and a corresponding taping station dedicated to bonding of the second adhesive layer 40 are reduced, which helps reduce costs.

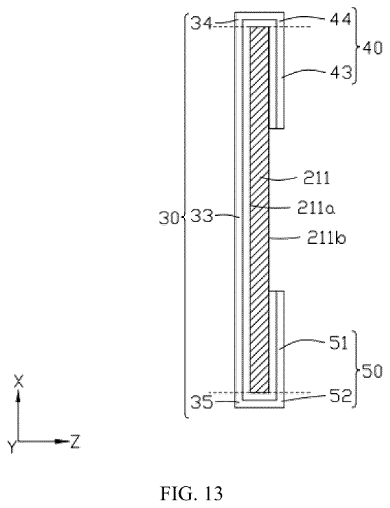

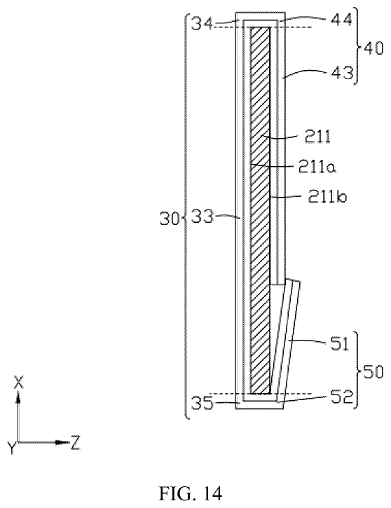

In some embodiments, referring to FIG. 13 and FIG. 14, the first adhesive layer 30 further includes a fifth portion 35, the fifth portion 35 exceeds the tail section 211 in the first direction X, and the fifth portion 35, the first portion 33, and the second portion 34 are connected sequentially in the first direction X; the secondary battery 100 further includes a third adhesive layer 50, the third adhesive layer 50 includes a seventh portion 51 pasted at the second surface 211b and an eighth portion 52 exceeding the tail section 211 in the first direction X, the third adhesive layer 50 is separated from the second adhesive layer 40, and the seventh portion 51 is connected to the eighth portion 52; and the third adhesive layer 50 and the second adhesive layer 40 are disposed sequentially in the first direction X. The eighth portion 52 and the fifth portion 35 are integrated into an adhesive layer, and in the third direction Z, at least part of the fourth portion 44 overlaps with the second portion 34, and at least part of the eighth portion 52 overlaps with the fifth portion 35. At least part of the eighth portion 52 overlaps with the fifth portion 35, which helps reduce the risk of bonding between the first bonding layer 32 of the fifth portion 35 and the housing 10, and further helps reduce a risk that the housing 10 drives the fifth portion 35 and the fifth portion 35 drives the first electrode plate 21 to be folded.

In some embodiments, referring to FIG. 14, in the third direction Z, the third portion 43 and the seventh portion 51 at least partially overlap, which helps increase an area of a part of the second adhesive layer 40 that covers the second surface 211b in the first direction X, thereby improving an effect of the second adhesive layer 40 to prevent exposure of debris generated by the first electrode plate 21 during a puncture test or an impact test, and further reducing a risk of a short circuit caused by contact between exposed debris of the first electrode plate 21 during the test and the second electrode plate 22. The third portion 43 and the seventh portion 51 at least partially overlap, which further helps reduce a risk of loosening the second adhesive layer 40 when the electrode assembly 20 is packaged and air is extracted.

In some embodiments, referring to FIG. 14, a sum of the length of the first adhesive layer 30 and lengths of the second adhesive layer 40 and the third adhesive layer 50 is greater than two times the width of the first electrode plate 21 in the first direction X, so that the third portion 43 and the seventh portion 51 at least partially overlap in the third direction Z, and a sum of the length of the first adhesive layer 30 and the lengths of the second adhesive layer 40 and the third adhesive layer 50 is less than or equal to four times the width of the first electrode plate 21 in the first direction X, which helps reduce a risk of increasing the thickness of the electrode assembly 20 after an excessively long adhesive layer is wound.

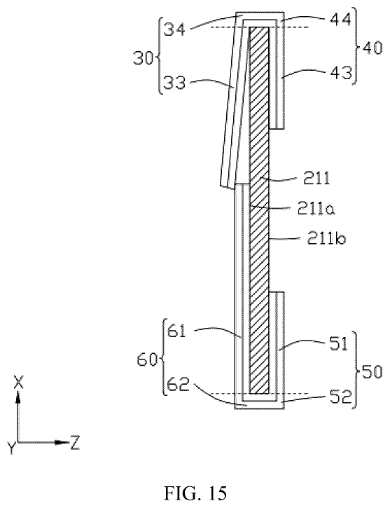

In some embodiments, referring to FIG. 15, the secondary battery 100 further includes a third adhesive layer 50 and a fourth adhesive layer 60, the third adhesive layer 50 is separated from the second adhesive layer 40, the third adhesive layer 50 includes a seventh portion 51 bonded on the second surface 211b and an eighth portion 52 exceeding the tail section 211 in the first direction X, and the seventh portion 51 is connected to the eighth portion 52. The fourth adhesive layer 60 is separated from the first adhesive layer 30, the fourth adhesive layer 60 includes a ninth portion 61 bonded on the first surface 211a and a tenth portion 62 exceeding the tail section 211 in the first direction X, and the ninth portion 61 is connected to the tenth portion 62. The eighth portion 52 and the tenth portion 62 are integrated into an adhesive layer, and in the third direction Z, at least part of the fourth portion 44 overlaps with the second portion 34, and at least part of the eighth portion 52 overlaps with the tenth portion 62. Arrangement of the foregoing third adhesive layer 50 and fourth adhesive layer 60 further helps increase an area of a part of the first surface 211a that is covered by the adhesive layer. In an embodiment in which the first section 2111a and the second section 2112a are disposed, attaching the first adhesive layer 30 to a junction of the first section 2111a and the second section 2112a helps reduce the risk of piercing through the separator 23 by an active substance trailing from the first section 2111a and a risk of lithium precipitation, and further helps reduce a risk of a short circuit caused by contact between the first electrode plate 21 and burrs at a tail of the second electrode plate 22 that pierces through the separator 23.

In some embodiments, referring to FIG. 15, in the third direction Z, the first portion 33 and the ninth portion 61 at least partially overlap, which further helps increase an area of a part of the first surface 211a that is covered by the adhesive layer. In addition, the first adhesive layer 30 is separated from the second adhesive layer 40, which reduces a risk of wrinkling caused by an excessively long continuous adhesive layer on the first surface 211a, thereby reducing air bubbles between the first portion 33, the fourth portion 44, and the first electrode plate 21.

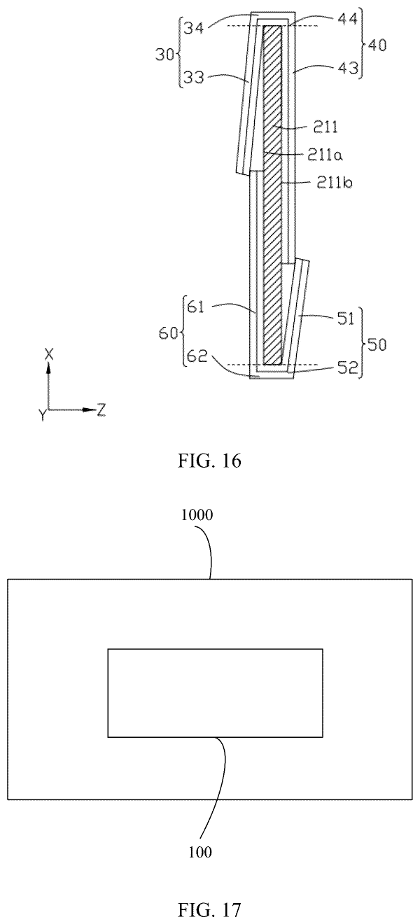

In some embodiments, referring to FIG. 16, in the third direction Z, the third portion 43 and the seventh portion 51 at least partially overlap, which helps increase an area of a part of the second surface 211b that is covered by the adhesive layer in the first direction X, and reduce a risk of wrinkling caused by an excessively long continuous adhesive layer on the second surface 211b, thereby reducing air bubbles between the third portion 43, the fourth portion 44, and the first electrode plate 21.

In some embodiments, there is first peel strength between the first portion 33 and the first surface 211a, there is second peel strength between the third portion 43 and the second surface 211b, and the first peel strength is less than the second peel strength, which reduces a risk of loss of adhesion between the first adhesive layer 30 and the second adhesive layer 40.

A test of the first peel strength between the first portion 33 and the first surface 211a is as follows:

The secondary battery 100 was disassembled to obtain the first electrode plate 21, and the first electrode plate 21 was soaked in dimethyl carbonate (DMC) for 4 hours, and the electrolyte was removed. Then the first electrode plate was heated at 85°° C. for 30 minutes, and cut to obtain a 10 cm×10 cm sample. The first bonding layer 32 of the first portion 33 was bonded on the first surface 211a of the sample, the second surface 211b of the sample was bonded onto a steel plate by using a double-sided tape (Nitto 5000NS), and the first portion 33 was bonded with an adhesive tape, one end of the adhesive tape was fixed at a tensile machine, the tensile machine pulled the adhesive tape at a speed of 50 mm/min in a direction of 180°, and tensile force (F·N) in a stable state was recorded, that is, the first peel strength between the first portion 33 and the first surface 211a.

For a test of the second peel strength between the third portion 43 and the second surface 211b, refer to the foregoing test of the first peel strength between the first portion 33 and the first surface 211a. Details are not described herein again.

In the embodiment in which the housing 10 includes a first end 15 and a second end 16 disposed opposite each other, the first electrode terminal 101 and the second electrode terminal 102 extend out of the housing 10 from the first end 15 in the first direction X, and the second portion 34 exceeds the first electrode plate 21 from the second end 16.

In some embodiments, when viewed along the first direction X, at least part of the second portion 34 overlaps with the first straight section 2111 or the second straight section 2113.

In some embodiments, at least part of the first portion 33 is bonded to the first surface 211a of the first straight section 2111 or the first surface 211a of the second straight section 2113, to reduce a thickness difference of the secondary battery 100 when the wound electrode assembly 20 ends at the first straight section 2111 or the second straight section 2113.

In some embodiments, the first adhesive layer 30 and the second adhesive layer 40 are disposed at a first side portion 2111b, a thickness of a part of the electrode assembly 20 that corresponds to the first side portion 2111b is less than a thickness of a part of the electrode assembly 20 that corresponds to a second side portion 2111c, so that an overall thickness of the electrode assembly 20 is not increased due to the first adhesive layer 30 and the second adhesive layer 40 along a direction from the first straight portion to the second straight portion, thereby helping reduce an overall size of the secondary battery 100 and further improve energy density of the secondary battery 100. In addition, the first adhesive layer 30 and the second adhesive layer 40 are located at a first side portion 2111b, which helps improve uniformity of thicknesses of the electrode assembly 20 along the direction from the first straight portion to the second straight portion, thereby reducing risks such as deformation and a drastic capacity decrease of the secondary battery 100 during cycling.

In some embodiments, the second electrode plate 22 ends at a curved side of the electrode assembly 20, that is, a position corresponding to the first bent section 2112 and the second bent section 2114. The tail section 211 of the first electrode plate 21 ends at the first straight section 2111 or the second straight section 2113, so that a side of the ending first straight section 2111 or second straight section 2113 that faces inwards is not adjacent to the second electrode plate 22, which helps vacate spacing to dispose the first adhesive layer 30 and reduce a risk of thickening the electrode assembly 20 due to the first adhesive layer 30.

Referring to FIG. 17, an embodiment of this application further provides an electronic apparatus 1000. The electronic apparatus 1000 includes the secondary battery 100 in any one of the foregoing embodiments. A probability of folding the first electrode plate 21 in the secondary battery 100 is reduced, which helps improve the reliability of the secondary battery 100, thereby improving the reliability of the electronic apparatus 1000.

Because the electronic apparatus 1000 uses the technical solution in any one of the foregoing embodiments of the secondary battery 100, the electronic apparatus has at least beneficial effects brought by the technical solution in any one of the foregoing embodiments. Details are not enumerated herein again.

In addition, a person of ordinary skill in the art should be aware of that the foregoing embodiments are only intended to describe this application, but not to limit this application. Appropriate modifications and variations made to the foregoing embodiments without departing from the essential spirit and scope of this application all fall within the scope of this application.

What is claimed is:

1. A secondary battery, wherein the secondary battery comprises:
a housing;
an electrode assembly disposed in the housing, wherein the electrode assembly comprises a first electrode plate, a second electrode plate, and a separator sandwiched between the first electrode plate and the second electrode plate; the first electrode plate, the second electrode plate, and the separator are stacked and wound, and a direction of a winding center axis of the electrode assembly is a first direction; and the first electrode plate comprises a tail section, the tail section forms an outermost ring of the electrode assembly, and the tail section comprises a first surface facing away from the housing and a second surface facing towards the housing;
a first adhesive layer comprising a first bonding layer, wherein the first adhesive layer comprises a first portion bonded on the first surface and a second portion exceeding the tail section in the first direction, and the first portion is connected to the second portion; and
a second adhesive layer comprising a second bonding layer, wherein the second adhesive layer comprises a third portion bonded on the second surface and a fourth portion exceeding the tail section in the first direction, and the third portion is connected to the fourth portion; in a thickness direction of the tail section, the second adhesive layer, the tail section, and the first adhesive layer are stacked sequentially, and the first bonding layer faces towards the second bonding layer; and in the thickness direction of the tail section, at least a part of the fourth portion overlaps with the second portion.

2. The secondary battery according to claim 1, wherein the first adhesive layer is separated from the second adhesive layer.

3. The secondary battery according to claim 2, wherein the first adhesive layer further comprises a fifth portion, the fifth portion exceeds the tail section in the first direction; and the fifth portion, the first portion, and the second portion are connected sequentially in the first direction; the second adhesive layer further comprises a sixth portion, the sixth portion exceeds the tail section in the first direction; and the sixth portion, the third portion, and the fourth portion are connected sequentially in the first direction; and at least a part of the sixth portion overlaps with the fifth portion in the thickness direction of the tail section.

4. The secondary battery according to claim 2, wherein the first adhesive layer further comprises a fifth portion, the fifth portion exceeds the tail section in the first direction; and the fifth portion, the first portion, and the second portion are connected sequentially in the first direction; the secondary battery further comprises a third adhesive layer, the third adhesive layer comprises a seventh portion bonded on the second surface and an eighth portion exceeding the tail section in the first direction; the third adhesive layer is spaced apart from the second adhesive layer, and the seventh portion is connected to the eighth portion; and at least a part of the eighth portion overlaps with the fifth portion in the thickness direction of the tail section.

5. The secondary battery according to claim 2, wherein the tail section comprises a first straight section, a first bent section, a second straight section, and a second bent section connected sequentially in a winding direction; the electrode assembly comprises a first end surface perpendicular to the first direction, and the second adhesive layer extends from the first straight section across the first end surface to the second straight section.

6. The secondary battery according to claim 1, wherein the second portion and the fourth portion are integrated into an adhesive layer.

7. The secondary battery according to claim 6, wherein the first adhesive layer further comprises a fifth portion, the fifth portion exceeds the tail section in the first direction; and the fifth portion, the first portion, and the second portion are connected sequentially in the first direction; the secondary battery further comprises a third adhesive layer, the third adhesive layer comprises a seventh portion pasted at the second surface and an eighth portion exceeding the tail section in the first direction, the third adhesive layer is spaced apart from the second adhesive layer, and the seventh portion is connected to the eighth portion; and the third adhesive layer and the second adhesive layer are disposed sequentially in the first direction; and
the eighth portion and the fifth portion are integrated into an adhesive layer, and in the thickness direction of the tail section, at least a part of the fourth portion overlaps with the second portion, and at least a part of the eighth portion overlaps with the fifth portion.

8. The secondary battery according to claim 7, wherein the third portion at least partially overlaps with the seventh portion in the thickness direction of the tail section.

9. The secondary battery according to claim 6, wherein the secondary battery further comprises a third adhesive layer and a fourth adhesive layer, the third adhesive layer comprises a seventh portion bonded on the second surface and an eighth portion exceeding the tail section in the first direction, the third adhesive layer is spaced apart from the second adhesive layer, and the seventh portion is connected to the eighth portion;
the fourth adhesive layer comprises a ninth portion bonded on the first surface and a tenth portion exceeding the tail section in the first direction, the fourth adhesive layer is spaced apart from the first adhesive layer, and the ninth portion is connected to the tenth portion; and
the eighth portion and the tenth portion are integrated into an adhesive layer, and in the thickness direction of the tail section, at least a part of the fourth portion overlaps with the second portion, and at least a part of the eighth portion overlaps with the tenth portion.

10. The secondary battery according to claim 1, wherein the housing is a packaging bag.

11. The secondary battery according to claim 10, wherein a first peel strength between the first portion and the first surface, is less than second peel strength between the third portion and the second surface.

12. The secondary battery according to claim 10, wherein the electrode assembly further comprises an electrode terminal, the housing comprises a first end and a second end disposed opposite to each other in the first direction, the electrode terminal is located at the first end, and the second portion and the fourth portion are located at the second end; and the housing further comprises a first packaging portion and a second packaging portion, and the first packaging portion and the second packaging portion are integrated at the second end.

13. The secondary battery according to claim 1, wherein the tail section comprises a first straight section, a first bent section, a second straight section, and a second bent section connected sequentially in a winding direction; and at least a part of the first portion is bonded on a first surface of the first straight section or a first surface of the second straight section.

14. The secondary battery according to claim 1, wherein in the first direction, a length of the second portion is L1, and a length of the fourth portion is L2, wherein L1<L2.

15. An electronic apparatus, comprising a secondary battery, wherein the secondary battery comprises:
a housing;
an electrode assembly disposed in the housing, wherein the electrode assembly comprises a first electrode plate, a second electrode plate, and a separator sandwiched between the first electrode plate and the second electrode plate; the first electrode plate, the second electrode plate, and the separator are stacked and wound, and a direction of a winding center axis of the electrode assembly is a first direction; and the first electrode plate comprises a tail section, the tail section forms an outermost ring of the electrode assembly, and the tail section comprises a first surface facing away from the housing and a second surface facing towards the housing;
a first adhesive layer comprising a first bonding layer, wherein the first adhesive layer comprises a first portion bonded on the first surface and a second portion exceeding the tail section in the first direction, and the first portion is connected to the second portion; and
a second adhesive layer comprising a second bonding layer, wherein the second adhesive layer comprises a third portion bonded on the second surface and a fourth portion exceeding the tail section in the first direction, and the third portion is connected to the fourth portion; in a thickness direction of the tail section, the second adhesive layer, the tail section, and the first adhesive layer are stacked sequentially, and the first bonding layer faces towards the second bonding layer; and in the thickness direction of the tail section, at least a part of the fourth portion overlaps with the second portion.

16. The electronic apparatus according to claim 15, wherein the first adhesive layer is separated from the second adhesive layer.

17. The electronic apparatus according to claim 16, wherein the first adhesive layer further comprises a fifth portion, the fifth portion exceeds the tail section in the first direction; and the fifth portion, the first portion, and the second portion are connected sequentially in the first direction; the second adhesive layer further comprises a sixth portion, the sixth portion exceeds the tail section in the first direction; and the sixth portion, the third portion, and the fourth portion are connected sequentially in the first direction; and at least a part of the sixth portion overlaps with the fifth portion in the thickness direction of the tail section.

18. The electronic apparatus according to claim 16, wherein the first adhesive layer further comprises a fifth portion, the fifth portion exceeds the tail section in the first direction; and the fifth portion, the first portion, and the second portion are connected sequentially in the first direction; the secondary battery further comprises a third adhesive layer, the third adhesive layer comprises a seventh portion bonded on the second surface and an eighth portion exceeding the tail section in the first direction; the third adhesive layer is spaced apart from the second adhesive layer, and the seventh portion is connected to the eighth portion; and at least a part of the eighth portion overlaps with the fifth portion in the thickness direction of the tail section.

19. The electronic apparatus according to claim 16, wherein the tail section comprises a first straight section, a first bent section, a second straight section, and a second bent section connected sequentially in a winding direction; the electrode assembly comprises a first end surface perpendicular to the first direction, and the second adhesive layer extends from the first straight section across the first end surface to the second straight section.

20. The electronic apparatus according to claim 15, wherein the second portion and the fourth portion are integrated into an adhesive layer.
